(19) United States
(12) Patent Application Publication
(10) Pub. No.: US 2007/0061254 A1
(43) Pub. Date: Mar. 15, 2007

(54) Systems and methods for opening, funding, and managing financial accounts

(76) Inventors: Richard Blunck, Snoqualmie, WA (US); Matthew Macomber, Walnut Creek, CA (US); Paul Willard, Seattle, WA (US); Richard Starbuck, Walnut Creek, CA (US)

Correspondence Address: PERKINS COIE LLP;PATENT-SEA, P.O. BOX 1247, SEATTLE, WA, 98111-1247, US

(21) Appl. No.: 11/522,294

(22) Filed: Sep. 15, 2006

Related U.S. Application Data
(60) Provisional application No. 60/717,389, filed on Sep. 15, 2005.
(60) Provisional application No. 60/792,179, filed on Apr. 14, 2006.

(51) Int. Cl. G06Q 40/00

(52) U.S. Cl. 705/39

(57) ABSTRACT

Systems and methods for opening, funding, and managing financial accounts are disclosed herein. In one embodiment, a method for opening and funding a financial account includes electronically receiving application information for a first account from a customer, verifying the identity of the customer and, after verification, establishing the first account. The method also includes depositing one or more microdeposits into a preexisting second account of the customer. The method then includes receiving electronically from the customer at the first account a monetary value of the one or more microdeposits. Before providing input regarding the monetary value of the one or more microdeposits, the customer securely logs into the first account by electronically providing selected personally-identifying information. The method further includes confirming the customer's input regarding the monetary value of the one or more microdeposits and, after confirmation, electronically funding the first account using a funds transfer from the second account.

### CROSS-REFERENCE TO RELATED APPLICATIONS

The present application claims priority to pending U.S. Provisional Patent Application No. 60/717,389, filed Sep. 15, 2005, and incorporated herein in its entirety by reference. The present application is also related to pending U.S. Provisional Patent Application No. 60/792,179, filed Apr. 14, 2006, and incorporated herein in its entirety by reference.

### TECHNICAL FIELD

The following disclosure relates generally to financial products and services and, more specifically, to systems and methods for opening, funding, and managing financial accounts.

### BACKGROUND

In recent years, financial institutions have increasingly provided customers with a number of options for remotely accessing account information and conducting various transactions. At most financial institutions, for example, customers can access their personal accounts using automatic teller machines (ATMs), telephone banking systems, and via the Internet using a personal computer. Customers can accordingly electronically pay bills, transfer funds between accounts, and conduct a variety of other transactions from a remote location.

While such remote banking systems have become commonplace for existing customers of financial institutions, one particular area that has lagged far behind is the ability of potential customers to open new accounts with a financial institution. For example, when a potential customer (i.e., an applicant) wishes to apply for a new account with a particular financial institution, the applicant generally needs to physically visit the institution because of the paperwork and processes required to authenticate the applicant's identity. Although some applicants can begin the account opening process electronically via the Internet, most applicants are generally required to physically send in a signature card and funds to complete the account opening process. These additional steps can take anywhere from several days to several weeks to complete. Because these manual processes are cumbersome and time-consuming, a significant number of applicants do not complete the process. Accordingly, there is a need to improve the process for opening, funding, and managing accounts at financial institutions.

### BRIEF DESCRIPTION OF THE DRAWINGS

FIG. 1 is a flow diagram illustrating stages in a method for opening and funding a financial account in accordance with several embodiments of the invention.

FIG. 2 is a flow diagram illustrating various stages in a method for opening a financial account, verifying an applicant's identity, and funding the new account from one or more of the applicant's external account in accordance with an embodiment of the invention.

FIGS. 3-12B are screen displays illustrating representative Web pages of various aspects of the method of FIG. 2.

FIG. 13 is a block diagram of a basic and suitable computer that may employ aspects of the invention.

FIG. 14A is a block diagram illustrating a simple, yet suitable system in which aspects of the invention may operate in a networked computer environment.

FIG. 14B is a block diagram illustrating an alternative system to that of FIG. 14A.

### DETAILED DESCRIPTION

A. Overview

The following disclosure describes various embodiments of systems and methods for opening, funding, and managing financial accounts. In one embodiment, for example, a method for opening a financial account includes electronically receiving application information for a first account from a customer, verifying the identity of the customer and, after verification, establishing the first account. The method also includes automatically depositing one or more microdeposits having a monetary value into a preexisting second account of the customer. The method then includes receiving personally-identifying information from the customer and, after verifying the information, providing secure access to the customer at the first account. After providing secure access to the customer at the first account, the method includes electronically receiving an input associated with the monetary value of the one or more microdeposits from the customer at the first account. The method further includes automatically confirming the customer's input regarding the monetary value of the one or more microdeposits and, after confirmation, electronically funding the first account using a funds transfer from the second account.

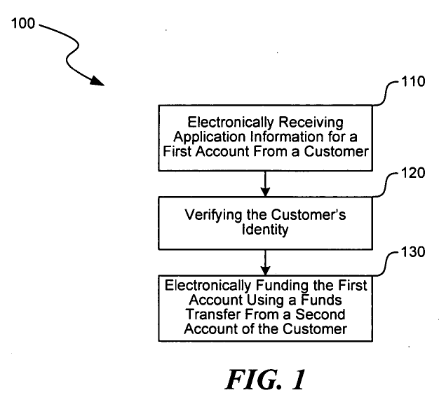

Certain specific details are set forth in the following description and FIGS. 1-14B to provide a thorough understanding of various embodiments of the invention. Well-known structures, systems and methods often associated with such systems have not been shown or described in detail to avoid unnecessarily obscuring the description of the various embodiments of the invention. In addition, those of ordinary skill in the relevant art will understand that additional embodiments of the invention may be practiced without several of the details described below.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

B. Embodiments of Systems and Methods for Opening, Funding, and Managing Financial Accounts

FIG. 1 is a flow diagram of a method 100 for opening and funding a financial account (e.g., a savings account, certificate of deposit, of other type of demand deposit account) in accordance with several embodiments of the invention. The method 100 can be performed by a bank or other financial institution in response to receiving a request from an applicant or customer. At stage 110, for example, the method 100 can include electronically receiving account application information for a first account from a customer. The account information can be submitted, for example, by a remote customer via a communications network (e.g., a Local Area Network (“LAN”), Wide Area Network (“WAN”) or the Internet). At stage 120, the method 100 includes verifying the customer's identity and, in many cases, checking the customer's credit history. The verification process can include, for example, a number of “out-of-wallet” questions (e.g., data that cannot be obtained from a stolen wallet or with only a small amount of research). The method 100 further includes electronically funding the first account at stage 130 using a funds transfer from a second account of the customer (e.g., an external account at another financial institution, another account at the same financial institution as the first account, a payment card such as a debit or credit card, and/or a peer-to-peer payment system such as PayPal®). In several embodiments, for example, the first account can be funded using an Automatic Clearing House (ACH) funds transfer from the customer's second account to the first account. The funding process at stage 130 may also include another authentication or validation step, such as a microdeposit process, to further improve security and reduce fraud.

One feature of the method 100 is that each of the steps in the method 100 can be completed online by the customer and, accordingly, the customer's new account is opened instantly or at least generally instantly. Compared with conventional methods for opening accounts described previously, several embodiments of the method 100 are expected to (a) substantially reduce the time and effort required by potential customers to complete the application process, (b) significantly improve the retention of potential customers who begin the online application process because the customer does not have to physically visit or return any paperwork to the financial institution, (c) reduce fraud because various embodiments of the method 100 include a number of identify verification and authentication processes, and (d) improve customer satisfaction and retention because online customers generally are offered better rates for financial products since online customers generally keep high balances and are easier to market other products and/or services than other customers.

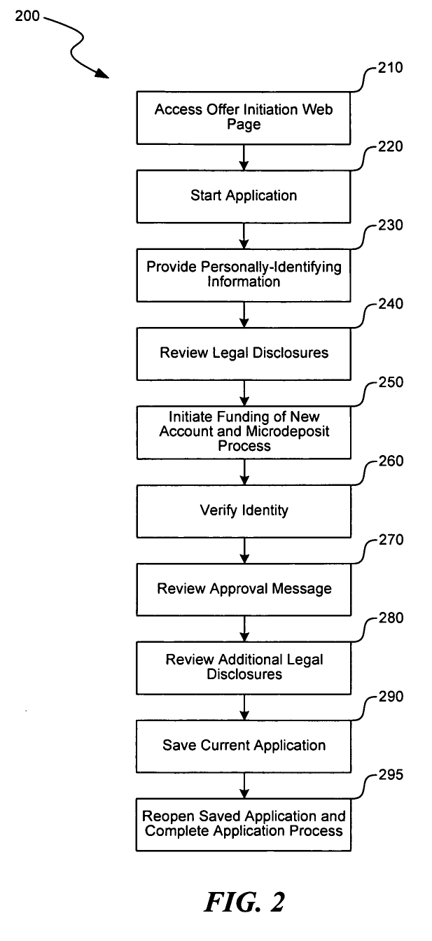

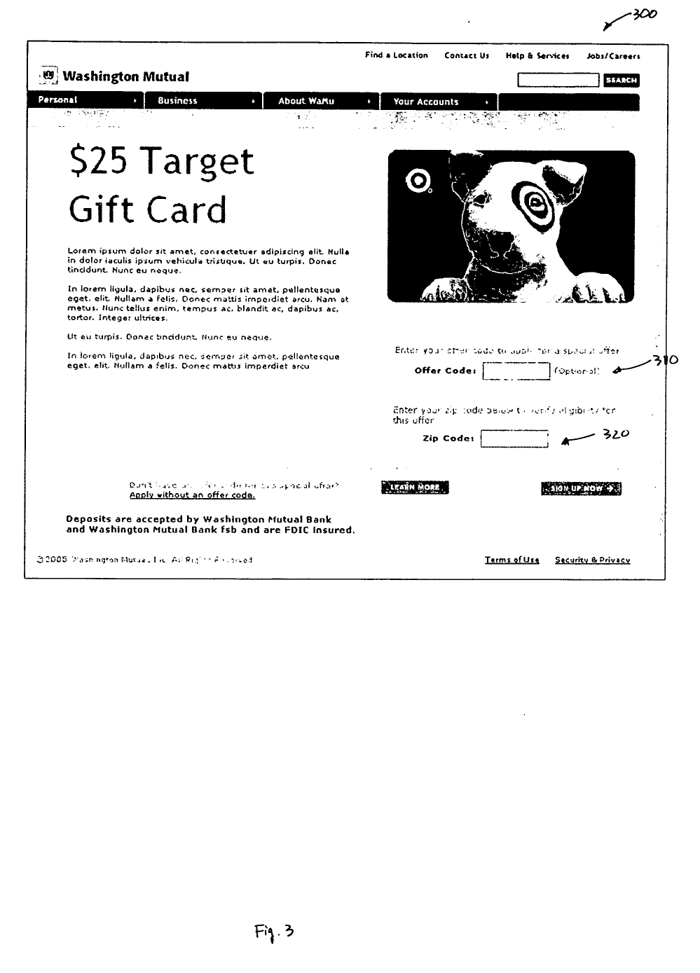

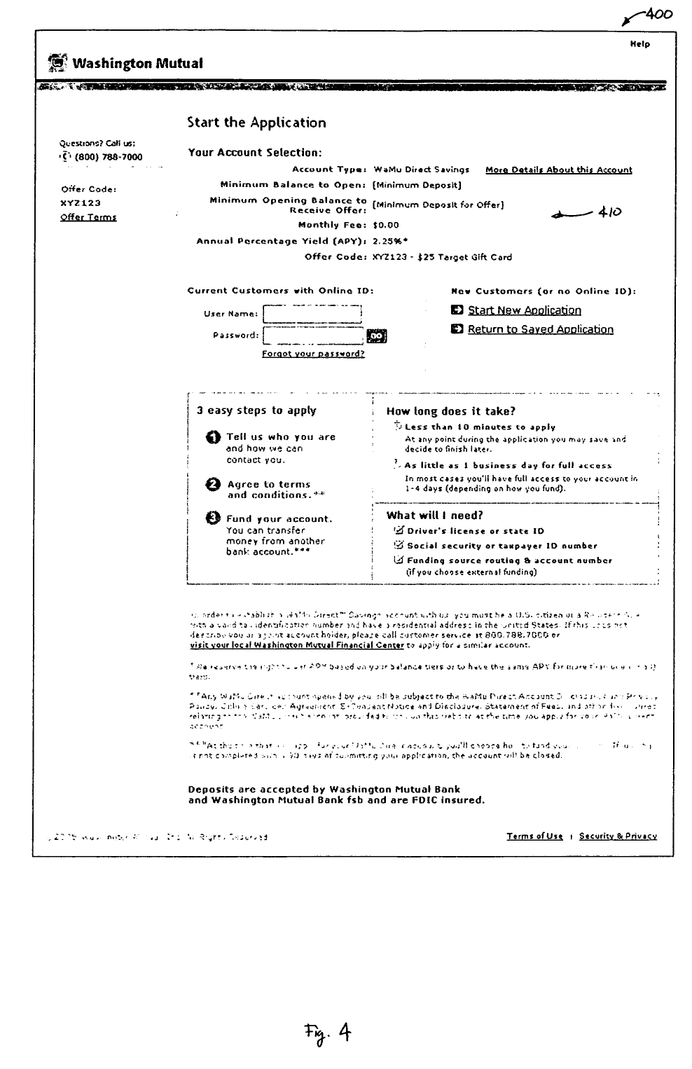

FIG. 2 is a flow diagram illustrating various stages in a method 200 for opening a financial account, verifying an applicant's identity, and funding the new account from one or more of the applicant's external accounts in accordance with an embodiment of the invention. In one aspect of this embodiment, the method 200 can be at least partially performed by the applicant from a remote location (e.g., the applicant's home computer). In other embodiments, however, the method 200 can be performed by other entities using other networked and/or non-networked devices to open other types of financial accounts. FIGS. 3-12B are screen displays illustrating representative Web pages of various aspects of the method 200. The following discussion refers to FIG. 2 to describe the various stages of the method 200, and FIGS. 3-12B to provide illustrations of representative Web pages in accordance with various aspects of the method 200. In other embodiments, the method 200 can include different stages and/or the screen shots illustrated in FIGS. 3-12B can have different arrangements and/or content.

At stage 210, the applicant accesses an offer initiation Web page to begin the process. The offer initiation process, for example, can include the applicant navigating to a landing page, such as a landing page 300 as shown in FIG. 3. The landing page 300 is generally an initial point of entry at which an applicant can start the application process. The applicant generally is directed to the landing page 300 through various marketing campaigns and channels (e.g., e-mail, mass media, banner ads, direct mail, and/or real-time personalization). The landing page 300 can include one or more redemption and/or validation entry portions 310 where the applicant can enter additional information (e.g., offer code, zip code, etc.) to verify that the applicant is entitled to participate in a particular offer or to validate the applicant's participation in a particular offer. The landing page 300 can be specifically tailored in conjunction with a particular promotion and, accordingly, in other embodiments the configuration and/or content of the landing page can be different than the landing page shown in FIG. 3.

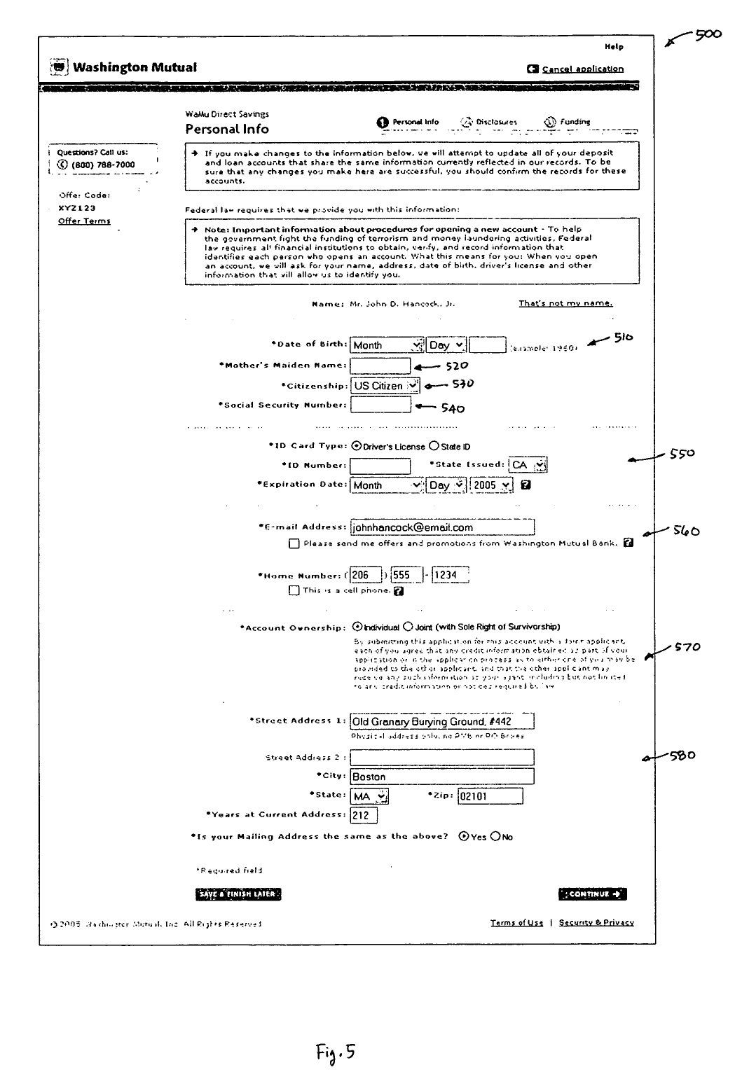

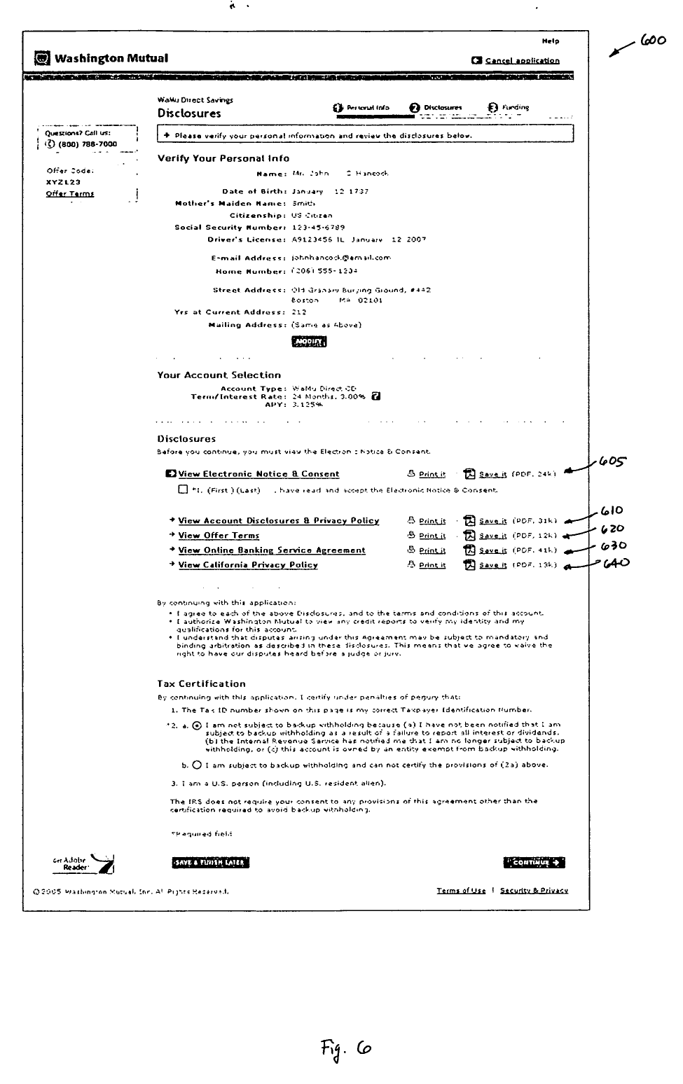

At stage 220 of the method 200, the applicant can start the application process. FIG. 4, for example, is one particular embodiment of a “start the application” page 400. The start page 400 can include an account selection portion 410 where the applicant can select a particular type of account or financial product. In the illustrated embodiment, for example, the applicant has selected to open a savings account. In other embodiments, the applicant can open other types of accounts, purchase Certificates of Deposits (CDs), or purchase other type of financial products.

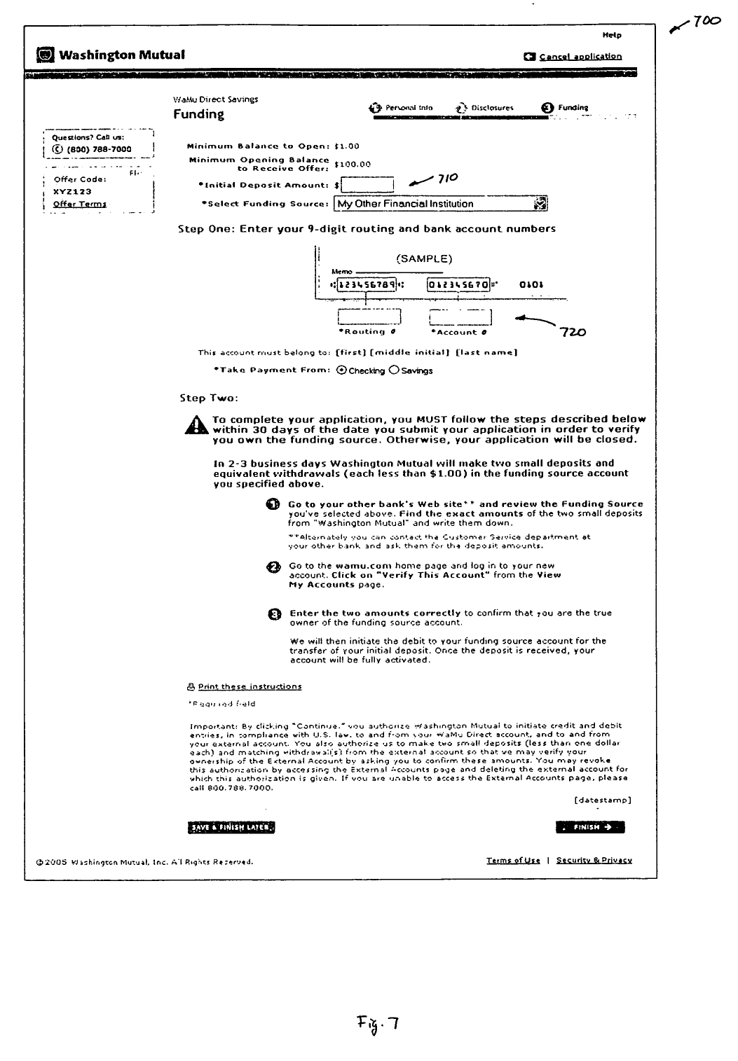

At stage 230, the method 200 continues with the applicant (or applicants in the case of joint applicants) providing a variety of personally-identifying information. Referring to FIG. 5, for example, a personal info page 500 in accordance with one embodiment of the invention can include a date of birth field 510, a mother's maiden name field 520, a citizenship field 530, and a social security number field 540. The personal info page 500 can also include an identification card field 550 for entry of driver's license or state ID card information, a contact information field 560 for entry of an e-mail address and phone number, an account ownership field 570 where the applicant can select an individual or joint account, and a home address field 580. In the case of joint applicants, one or more additional personal info pages can be included for the joint applicant to enter personally-identifying information. In other embodiments, the personal info page 500 can include other arrangements and/or request different information from the applicant.

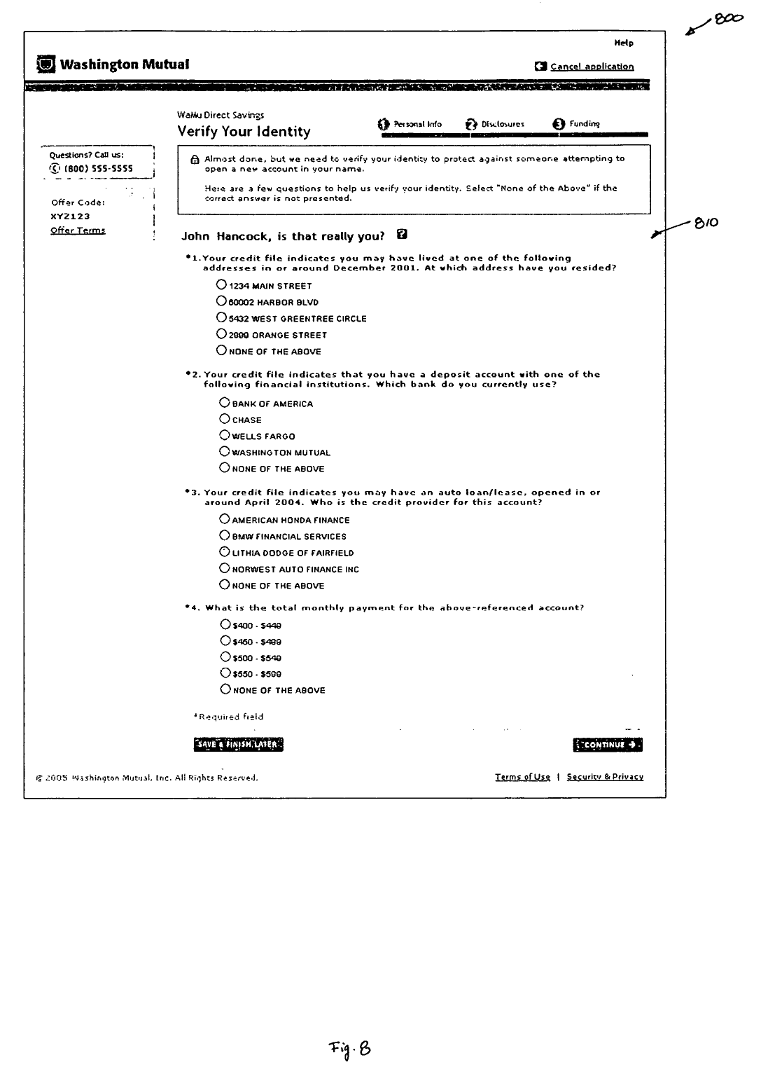

At stage 240, the applicant is provided with a number of legal disclosures for review, such as those required by federal and state banking laws. Referring to FIG. 6, for example, a disclosure page 600 in accordance with one embodiment of the invention can include an electronic notice and consent agreement 605 that the applicant must view and accept (e.g., by clicking the checkbox to affirm that the applicant has read and accepted the terms of the agreement). One particular aspect of this embodiment is that when the applicant clicks the link to view the electronic notice and consent agreement 605 (or any number of additional disclosures), the agreement 605 is presented in a new window (e.g., a pop-up window) for viewing. The method 200 can include verification by the financial institution that the entire notice and consent agreement 605 has been displayed in the pop-up window before the applicant can click the checkbox to provide acceptance of the terms of the agreement. One advantage of the verification feature is that the financial institution can confirm the applicant viewed the agreement before accepting the terms, even if the applicant's system includes software or other devices that generally inhibit pop-up windows. The disclosure page 600 can also include a number of other disclosures such as an account disclosure and privacy policy 610, an offer terms disclosure 620, an online banking service agreement 630, and a state-specific privacy policy disclosure 640. In other embodiments, the disclosure page 600 can include a different set of disclosures.

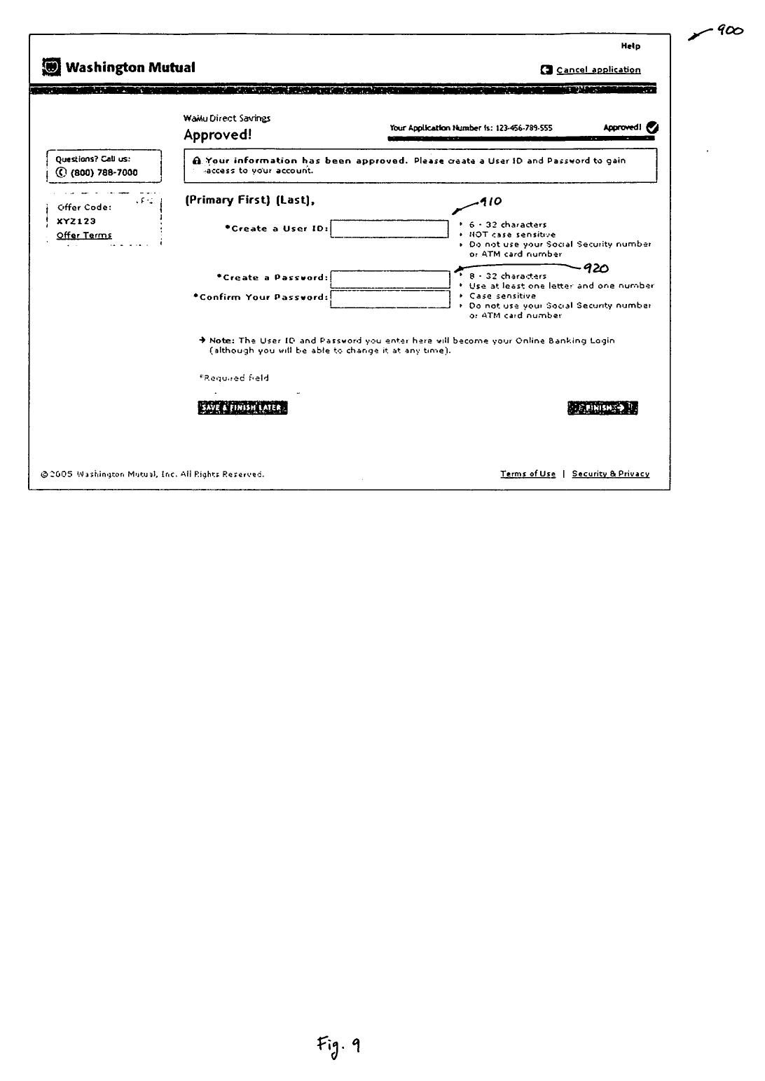

The method 200 continues at stage 250 with initiation of the funding process for the new account. Referring to FIG. 7, for example, a funding page 700 can include an initial deposit field 710 where the applicant can select an amount to deposit into the new account. The new account is funded from one of the applicant's external accounts (e.g., a savings or checking account at another financial institution, a payment card such as a debit or credit card, and/or a peer-to-peer payment system such as PayPal®). In some instances, the “external” account can include a different account at the same institution where the new account is being opened. In the case where the “external” account is at the same financial institution as the new account, the method can include a number of different steps than those described below. For example, several verification processes may not be necessary when the applicant already has an account at the particular institution. In other cases, however, the additional verification processes may still be used. The funding page 700 can also include account information fields 720 (e.g., routing number, account number, name of account, type of account, etc.) where the applicant can specify particular information about the external account that will be used to fund the new account.

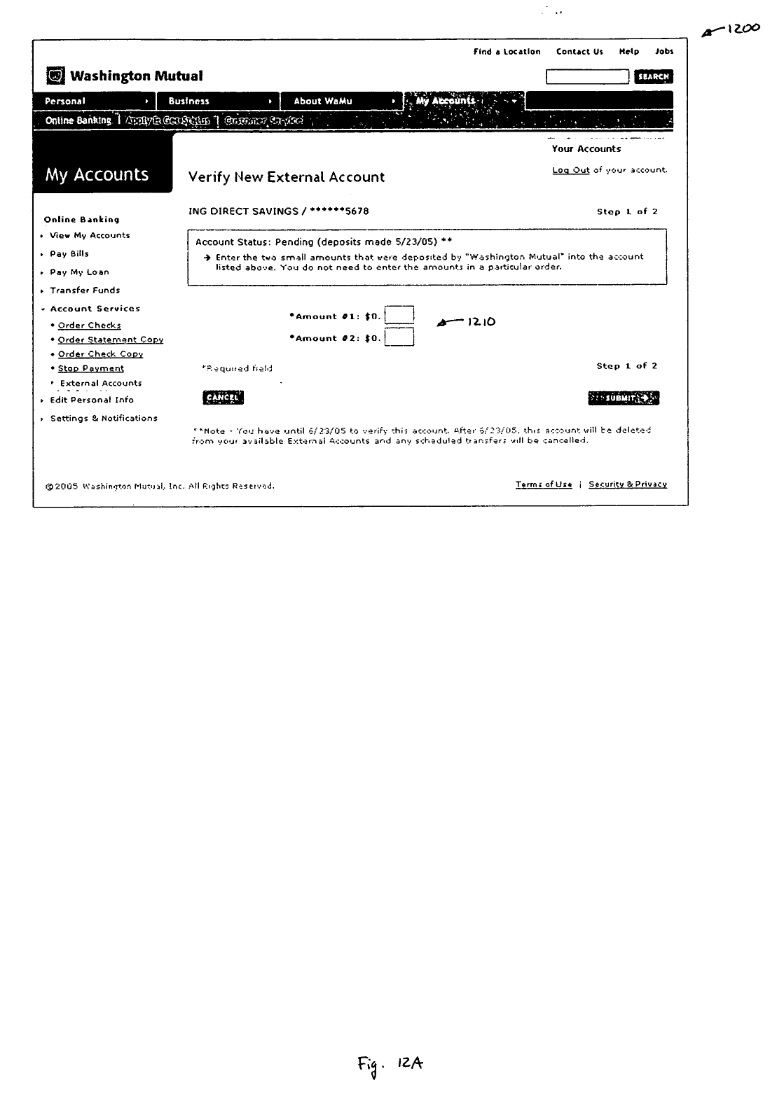

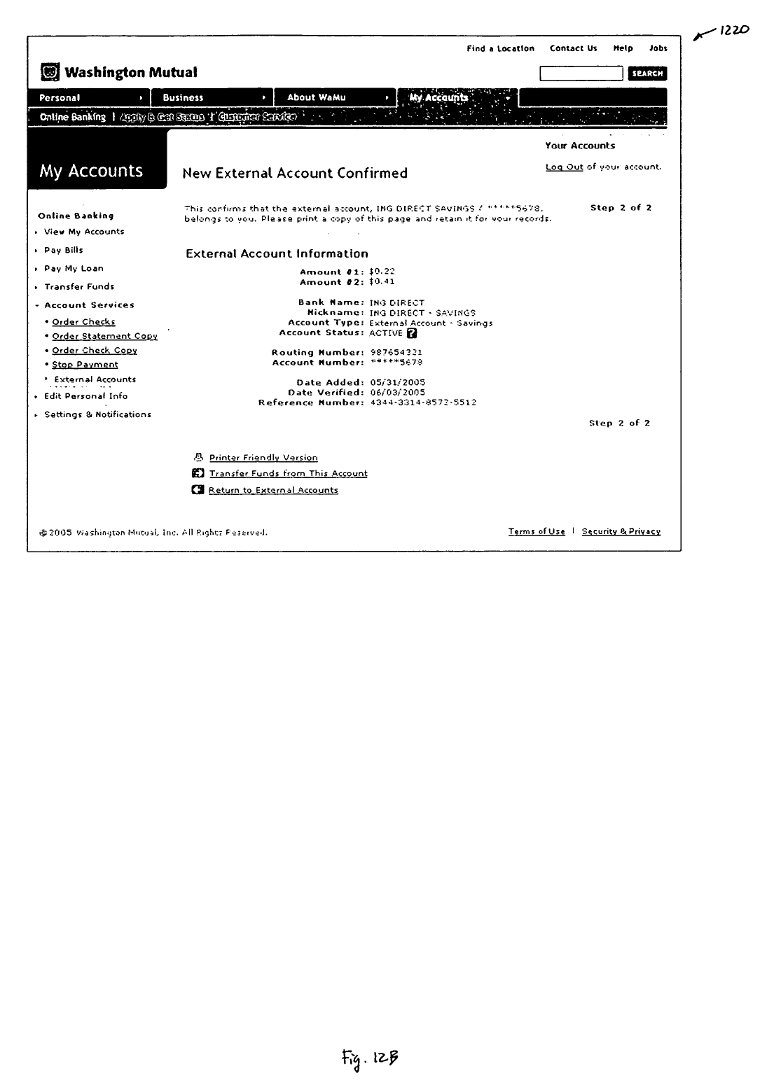

One particular aspect of this embodiment is that the funding step includes a microdeposit process. The microdeposit process includes a number of small deposits and equivalent withdrawals (the illustrated embodiment includes two) being made in the selected external account before the new account is fully funded. Before funding, the applicant (a) checks the external account and reviews the amounts of the microdeposits (which are generally less than $1.00) and makes a note of the amounts. The applicant then returns to the newly opened account and verifies the amounts of the microdeposits (as described below with respect to FIGS. 12A and 12B). The microdeposit process accordingly provides an additional level of security to further confirm that the applicant is the true owner of the external account that will fund the new account.

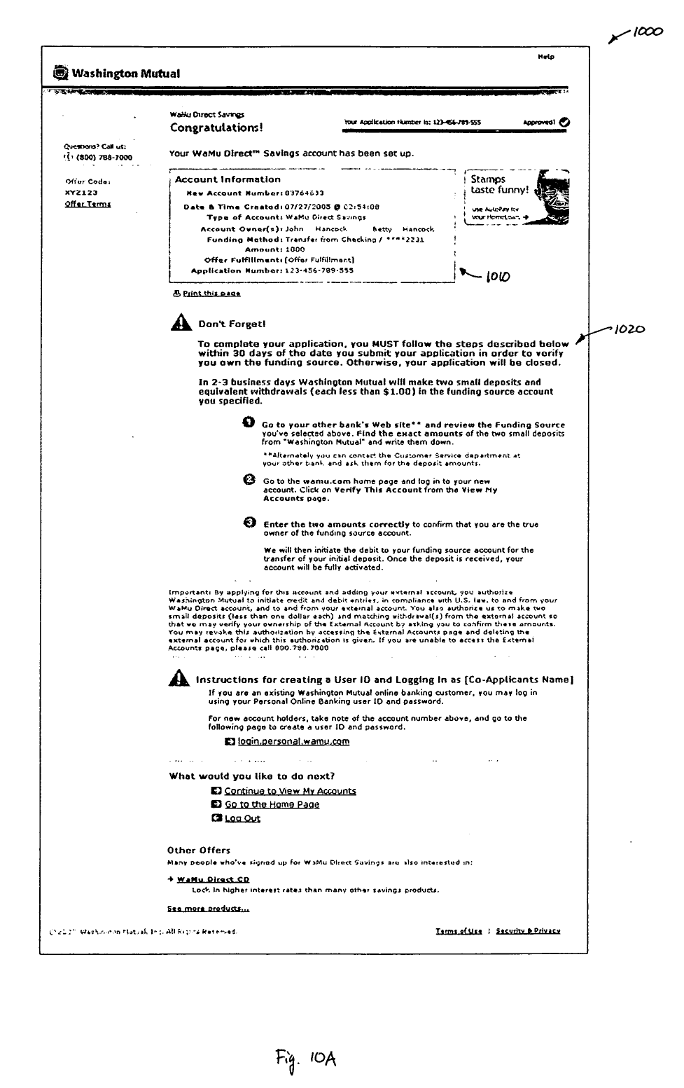

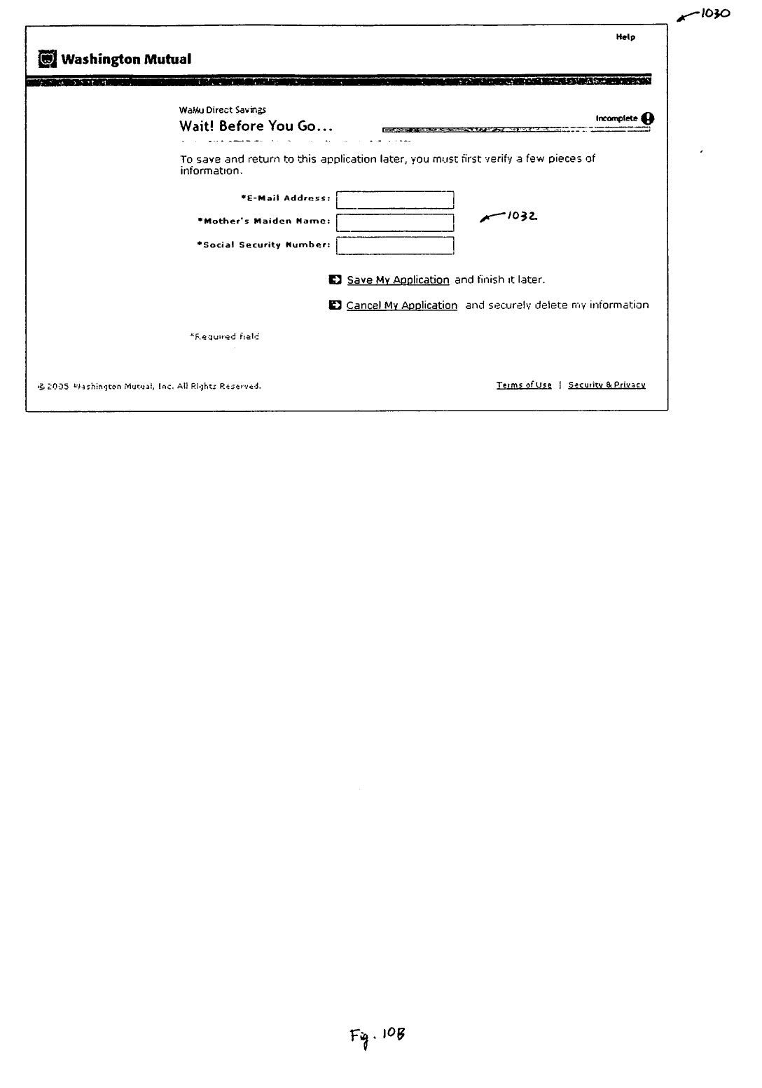

After initiation of the funding process, the method 200 can include an identity verification process at stage 260. FIG. 8, for example, includes an identity verification page 800 including a series of out-of-wallet questions. The out-of-wallet questions can include a number of questions that are unique to a particular applicant (e.g., based on information from the applicant's credit report) and help prevent a third-party from opening an unauthorized account using the applicant's identity. In several embodiment, the identify verification process can also include checking the applicant's Internet Protocol (IP) address and/or other HTTP-type information (e.g., operating system, system clock time, etc.) These additional verification processes can further reduce fraud or unauthorized access.

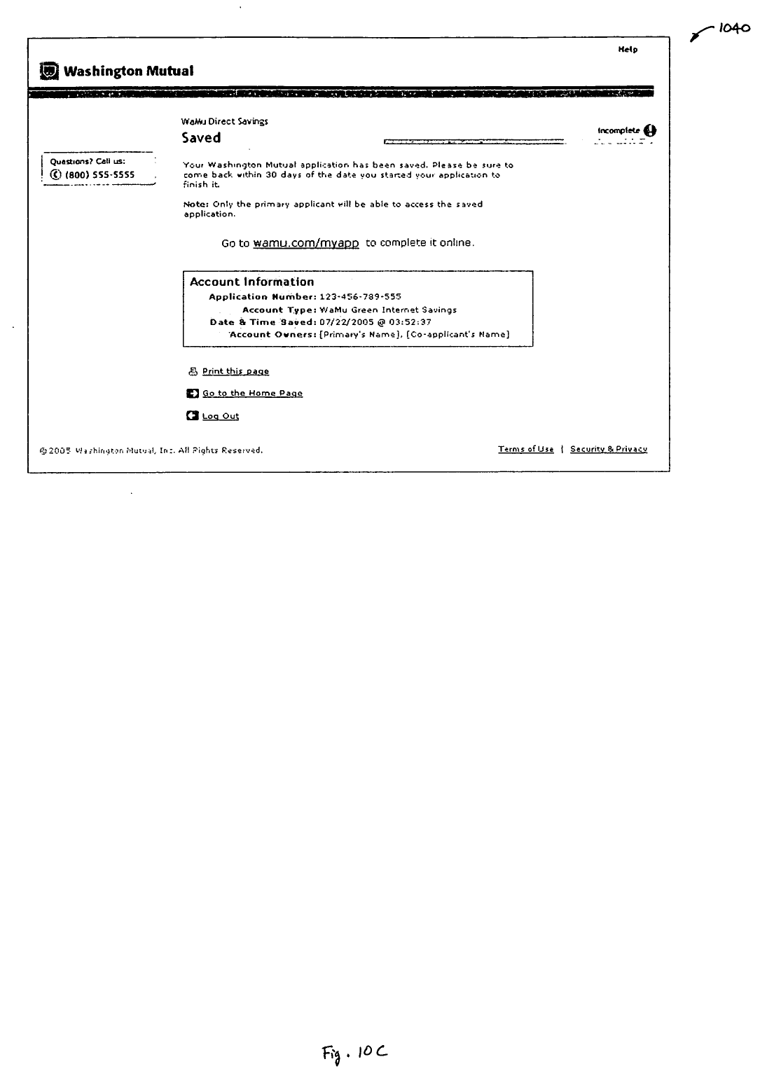

After successfully answering each of the questions on the identify verification page 800, the applicant's identify is verified and the method 200 continues at stage 270 with display of an approval message. Referring to FIG. 9, for example, an approval page 900 in accordance with one embodiment of the invention can include notification that the applicant's information has been approved and a user identification field 910 and password field 920 for the applicant to select an ID and password for the new account. At stage 280, the method 200 can include an additional disclosure step where the applicant is again provided with a number of disclosures related to the new account.

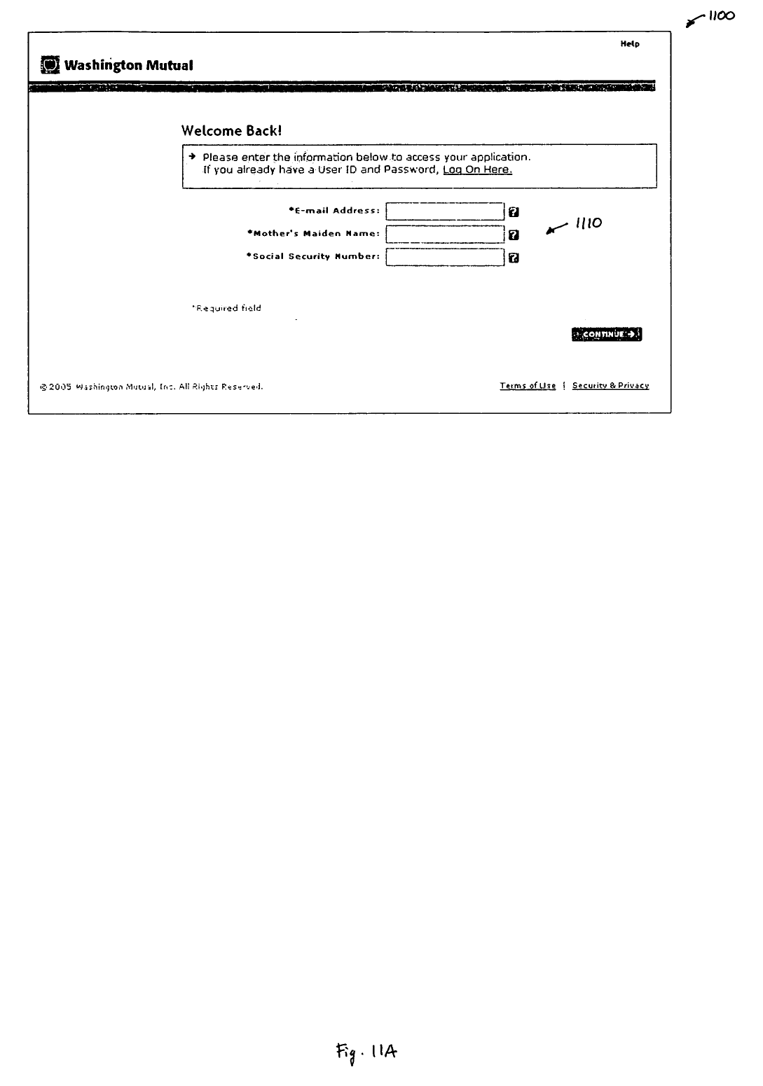

At stage 290, the method 200 can include saving the applicant's current application and providing instructions to the applicant about returning to the saved application to complete the application process (e.g., entering the microdeposit information). Referring to FIG. 10A, for example, an overview and status page 1000 can include a detailed account information portion 1010 and a microdeposit instruction portion 1020. The overview and status page 1000 can also include a reminder to the applicant to create a user ID so that the applicant can easily return to the saved application to complete the funding process.

Referring next to FIG. 10B, a save application page 1030 can include one or more verification fields 1032 requesting verification of certain personally-identifying information (e.g., e-mail address, mother's maiden name, and social security number) from the applicant before the applicant exits the application process. In other embodiments, however, the verification fields 1032 can request other types of information in addition to, or in lieu of, the personally-identifying information described above. In some embodiments, for example, one or more verification fields 1032 can request verification of certain “shared secret” information (e.g., the name of applicant's favorite pet, etc.) The shared secret information can be provided at any point in the method 200 prior to stage 290. The verification information can be used to verify the applicant's identity when the applicant returns to the application to complete the application process (e.g., after the microdeposits have been sent to the applicant's external account). Referring to FIG. 10C, a save confirmation page 1040 can include confirmation that applicant's account application has been saved and provide instructions to the applicant regarding completion of the application.

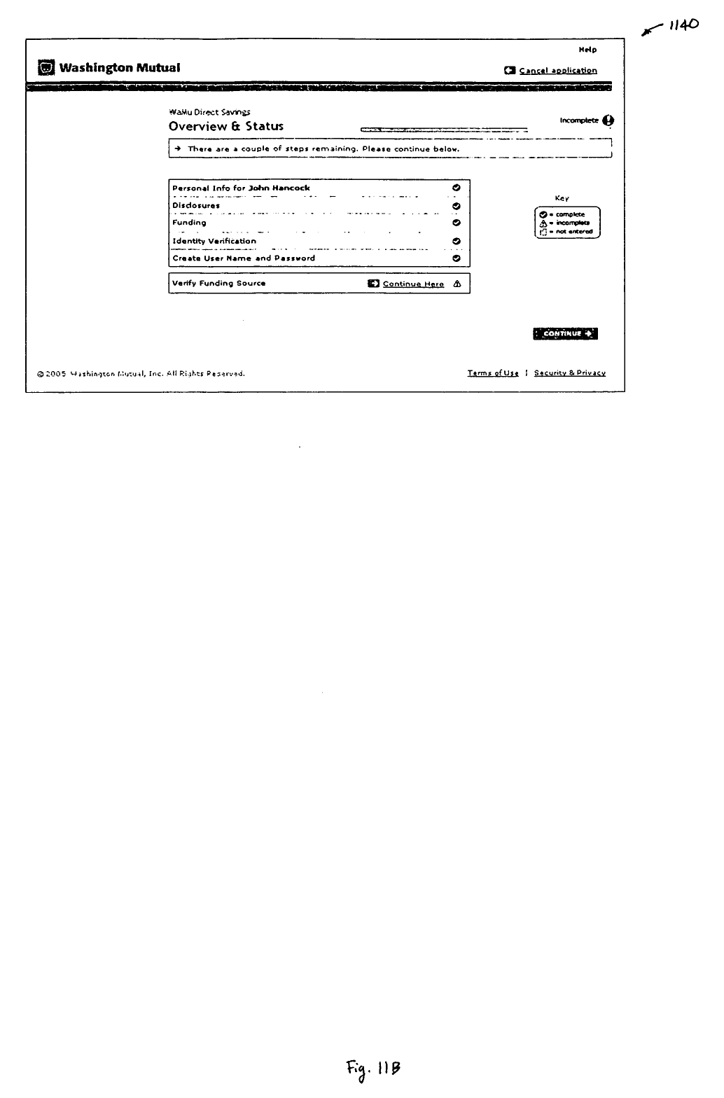

At stage 295, the method 200 can include reopening the saved application to complete the application process. Referring to FIG. 11A, for example, the applicant can navigate to a welcome back page 1100 and enter the appropriate verification information into the verification fields 1110. The information in the verification fields 1110 generally corresponds to the verification fields 1032 of the save application page 1030 in FIG. 10B. One particular aspect of this embodiment is that the applicant can reopen an incomplete application by merely providing the requested verification information (e.g., e-mail address, mother's maiden name, and social security number). There is no further information required from the applicant, such as additional log-in passwords or system-generated strings. One advantage of this feature is that it can be relatively easy for the applicant to return to the saved application to complete the application process as compared with conventional systems that require additional steps or processes to return to the saved application. This feature can accordingly further increase the number of applicants who successfully complete the application process.

Referring next to FIG. 11B, a status page 1140 includes an overview of the status of the various steps of the application process and provides instructions to the applicant regarding any remaining steps to be completed. In the illustrated embodiment, for example, the “verify funding source” step still remains to be completed. By clicking on this link, the applicant is directed to verify the external account (e.g., using the microdeposit information). Referring to FIGS. 12A and 12B, for example, a first account verification page 1200 includes one or more microdeposit verification fields 1210 (two are shown in the illustrated embodiment) to enter the exact amounts of the microdeposits deposited into the applicant's external account. After entering the microdeposits, a second account verification page 1220 (FIG. 12B) informs the applicant that the microdeposit information is correct and confirms selected information regarding applicant's external account that will fund the applicant's newly created account.

One particular aspect of this embodiment is that the applicant must log back in to the application process before entering the microdeposit information. An advantage of this feature is that it improves security, and thereby reduces fraud, because the microdeposit confirmation steps are completed after the user logs back in to the application, as opposed to many conventional microdeposit systems where the confirmation pages are outside of a user login portion of the application.

C. Suitable Computing Environments in Which Aspects of the Invention can be Implemented

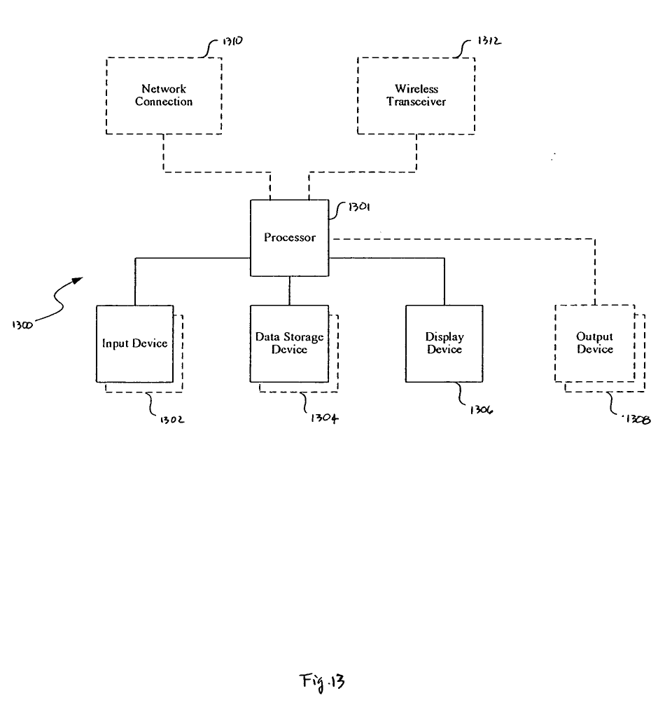

FIG. 13 and the following discussion provide a brief, general description of a suitable computing environment in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a LAN, WAN, or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 13, one embodiment of the invention employs a computer 1300, such as a personal computer or workstation, having one or more processors 1301 coupled to one or more user input devices 102 and data storage devices 1304. The computer is also coupled to at least one output device such as a display device 1306 and one or more optional additional output devices 1308 (e.g., printer, plotter, speakers, tactile or factory output devices, etc.). The computer may be coupled to external computers, such as via an optional network connection 1310, a wireless transceiver 1312, or both.

The input devices 1302 may include a keyboard and/or a pointing device such as a mouse. Other input devices are possible such as a microphone, joystick, pen, game pad, scanner, digital camera, video camera, and the like. The data storage devices 1304 may include any type of computer-readable media that can store data accessible by the computer 1300, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a LAN, WAN, or the Internet (not shown in FIG. 13).

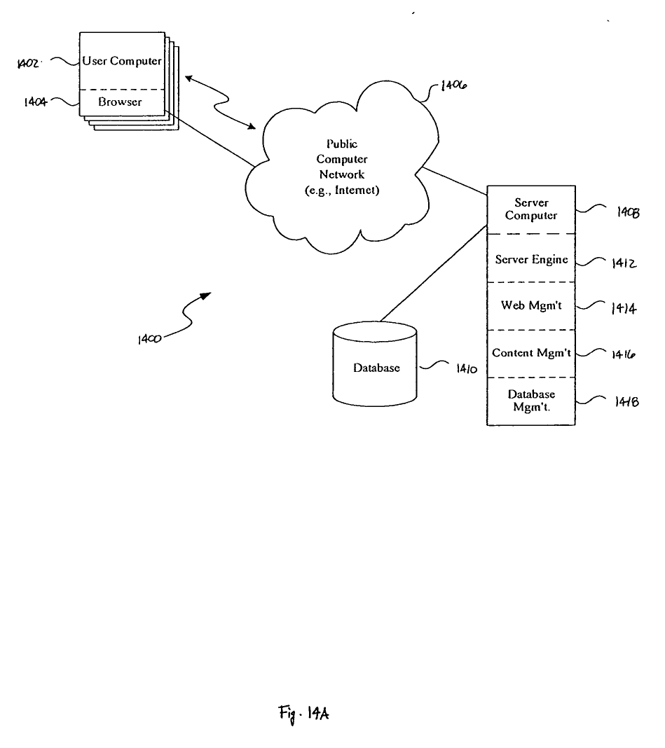

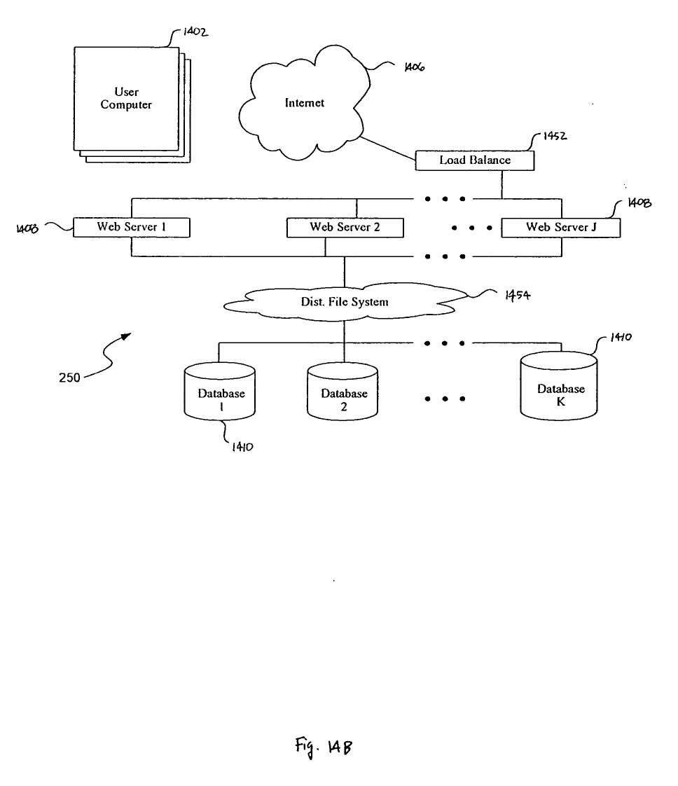

Aspects of the invention may be practiced in a variety of other computing environments. For example, referring to FIG. 14A, a distributed computing environment with a web interface includes one or more user computers 1402 in a system 1400 are shown, each of which includes a browser program module 1404 that permits the computer to access and exchange data with the Internet 1406, including web sites within the World Wide Web portion of the Internet. The user computers may be substantially similar to the computer described above with respect to FIG. 13. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 1408, coupled to the Internet or World Wide Web (“Web”) 206, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 1410 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 1408 may include a server engine 1412, a web page management component 1414, a content management component 1416 and a database management component 1418. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data.

Referring to FIG. 14B, an alternative embodiment to the system 1400 is shown as a system 1450. The system 1450 is substantially similar to the system 1400, but includes more than one server computer (shown as server computers 1, 2, . . . J). A load balancing system 1452 balances load on the several server computers. Load balancing is a technique well-known in the art for distributing the processing load between two or more computers, to thereby more efficiently process instructions and route data. Such a load balancer can distribute message traffic, particularly during peak traffic times.

A distributed file system 1454 couples the web servers to several databases (shown as databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

Conclusion

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, a number of aspects of the invention may be embodied in a computer-readable medium. Accordingly, the inventors reserve the right to add additional claims after filing the application to pursue such additional claim forms for other aspects of the invention.

We claim:

1. A method for opening a financial account, the method comprising:
electronically receiving application information for a first account from a customer;
verifying the identity of the customer;
establishing the first account when the identity of the customer has been verified;
automatically depositing one or more microdeposits into a preexisting second account of the customer, wherein the microdeposits have a monetary value;
providing secure access to the customer at the first account after receiving and verifying personally-identifying information from the customer;
electronically receiving an input associated with the monetary value of the one or more microdeposits from the customer at the first account after providing secure access to the customer at the first account; and
automatically confirming the monetary value of the one or more microdeposits and, after confirmation, electronically funding the first account using a funds transfer from the second account.

2. The method of claim 1 wherein verifying the identity of the customer comprises:
obtaining credit information related to the customer;
presenting multiple questions to the customer based on a profile generated from the credit information; and
comparing the responses by the customer to the questions with the credit information and, if the responses match, approving establishment of the first account.

3. The method of claim 1, further comprising requesting a user identification and password from the customer after establishing the first account and before automatically depositing one or more microdeposits into the preexisting second account.

4. The method of claim 1 wherein:
electronically receiving application information from a customer comprises receiving the account information from a remote customer via a communications network; and
verifying the identity of the customer further comprises checking the Internet Protocol (IP) address and/or other HTTP-type information of the customer.

5. The method of claim 1 wherein electronically receiving application information for a first account from a customer comprises receiving at least the customer's name, home address, date of birth, social security number, state driver's license or state identification number, electronic mail address, and phone number.

6. The method of claim 1 wherein automatically depositing one or more microdeposits into a preexisting second account of the customer occurs one or more business days after electronically receiving application information and verifying the identity of the customer.

7. The method of claim 1 wherein receiving and verifying personally-identifying information from the customer comprises receiving and verifying at least the customer's electronic mail address, mother's maiden name, and social security number.

8. The method of claim 1 wherein providing secure access to the customer at the first account after receiving and verifying personally-identifying information does not include providing a system-generated string and/or a user identification and password.

9. The method of claim 1, further comprising:
presenting one or more legal disclosures to the customer for review and acceptance before verifying the identity of the customer; and
receiving an input from the customer confirming agreement to the terms of the one or more disclosures before establishing the first account.

10. The method of claim 1 wherein electronically funding the first account using a funds transfer from a second account includes using an Automatic Clearing House (ACH) funds transfer from the second account to the first account.

11. The method of claim 1 wherein electronically funding the first account using a funds transfer from a second account includes using a payment card, a debit card, a credit card, and/or a peer-to-peer payment system.

12. The method of claim 1 wherein the first account is at a first financial institution, and wherein electronically funding the first account using a funds transfer from a second account of the customer includes funding the first account from a second account at a second different financial institution.

13. The method of claim 1 wherein the first account is at a first financial institution, and wherein electronically funding the first account using a funds transfer from a second account of the customer includes funding the first account from a second account at the first financial institution.

14. A computer-readable medium containing instructions causing one or more computers to perform a method comprising:
receiving application information for a first demand deposit account from a remote applicant;
obtaining credit information related to the applicant and creating multiple out-of-wallet identity verification questions based upon the credit information;
comparing responses by the applicant to the multiple questions and, if the responses match, establishing the first account; and
electronically funding the first account using a funds transfer from a preexisting second account of the customer, wherein the funding process includes
automatically depositing two or more microdeposits into the second account after establishing the first account, wherein the microdeposits having a monetary value;
providing secure access to the applicant at the first account after receiving and authenticating selected personally-identifying verification information from the applicant;
receiving an input from the applicant at the first account associated with the monetary value of the two or more microdeposits after providing secure access to the applicant; and
after automatically confirming the input from the applicant at the first account matches the monetary value of the two or more microdeposits, funding the first account using an electronic funds transfer from the second account.

15. The computer-readable medium of claim 14, further comprising:
presenting one or more legal disclosures to the applicant for review and acceptance; and
receiving an input from the applicant confirming agreement to the terms of the one or more disclosures before establishing the first account.

16. The computer-readable medium of claim 14 wherein electronically funding the first account using a funds transfer from a second account comprises using an ACH funds transfer, using a payment card, and/or using a peer-to-peer payment system.

17. The computer-readable medium of claim 14 wherein receiving and authenticating selected personally-identifying verification information from the applicant comprises receiving and authenticating at least an electronic mail address, a mother's maiden name, and a social security number of the applicant.

18. A system for opening, funding, and managing a financial account, the system comprising:
means for receiving application information for a first account from a remote applicant and establishing the first account after verification of identity and credit information related to the applicant;
means for depositing one or more microdeposits into a preexisting second account of the applicant;
means for receiving from the applicant at the first account an input confirming a monetary value of the one or more microdeposits, wherein the input confirming the monetary value is received after the applicant has securely logged into the first account; and
means for funding the first account using a funds transfer from the second account.

19. The system of claim 18 wherein the means for funding the first account from the second account comprises an ACH funds transfer, a credit card, a debit card, and/or a peer-to-peer payment system.

20. The system of claim 18, further comprising:
means for presenting one or more legal disclosures to the applicant for review; and
means for receiving an input from the customer confirming agreement to the terms of the one or more disclosures before establishing the first account.
